(19) United States
(12) Patent Application Publication
(10) Pub. No.: US 2023/0213327 A1
(43) Pub. Date: Jul. 6, 2023

(54) SLANTED OPTICAL COHERENCE TOMOGRAPHY IMAGING FOR HIGH-SPEED INSPECTION

(71) Applicant: HAMAMATSU PHOTONICS K.K., Hamamatsu-shi, Shizuoka (JP)

(72) Inventors: Peter SEITZ, Solothurn (CH); Helmut TEICHMANN, Solothurn (CH)

(73) Assignee: HAMAMATSU PHOTONICS K.K., Hamamatsu-shi, Shizuoka (JP)

(21) Appl. No.: 18/008,711

(22) PCT Filed: Jul. 1, 2020
(86) PCT No.: PCT/JP2020/025830

§ 371 Date: Dec. 7, 2022

(51) Int. Cl. G01B 9/02091

(52) U.S. Cl. CPC G01B 9/02091

(57) ABSTRACT

An optical coherence tomography imaging system includes a light source, a lens for converting light emitted from the light source into a plane wave, a beam splitter for splitting the plane wave into a first part and a second part, an imaging lens for focusing the first part of the plane wave into the object and imaging object light from a focal plane into a plane of an image sensor, and a reference optical system for modulating an optical beam path and propagating the second part of the plane wave, as a reference wave, into the plane of the image sensor. Interference light of the reference wave and the object light is detected by the image sensor. The optical axis of the optical coherence tomography imaging system is slanted at an angle to a surface normal of the object.

### TECHNICAL FIELD

One aspect of the present disclosure relates to optical coherence tomography (OCT) systems, making use of white-light interferometric setups with low-coherence light sources, for the three-dimensional imaging of moving objects with depth-varying reflection and scattering properties.

In particular, one aspect of the present disclosure relates to OCT systems without large moving optomechanical elements, where all light-scattering points in the object are simultaneously in focus in a slanted focal plane in the object, for diffraction-limited lateral resolution of the complete generated OCT images.

### BACKGROUND ART

Optical coherence tomography measurement systems make use of interferometric setups with low-coherence light sources, with the aim of imaging the internal three-dimensional structure of objects which have spatially varying scattering and reflection properties.

### SUMMARY OF INVENTION

### Technical Problem

The best three-dimensional OCT image quality is obtained with implementations of the OCT principle according to the time-domain OCT principle (TD-OCT). This is achieved by mechanically moving not only the reference mirror but simultaneously also the imaging lens and with it the focus plane, such that the focus distance and the reference distance are always identical. Under these circumstances the lateral resolution of the resulting TD-OCT image always has the ultimate lateral spatial resolution given by the diffraction limit of the imaging lens. Unfortunately, this requires a mechanical system for the transport of a multitude of optical components, so that the resulting system has a scanning speed that is limited by the speed of the mechanical transport sub-system containing the imaging lens. Therefore, known TD-OCT systems are not suited for the 3D imaging of continuously moving objects such as in conveyor-belt applications.

Faster acquisition of OCT imagery is possible with OCT setups that do not require mechanically scanning components, such as the Fourier-domain OCT principle (FD-OCT), or the swept-source OCT principle (SS-OCT). These methods allow the acquisition of the complete 3D scattering pattern in a single, spectrally resolved measurement. However, the focus plane in these OCT principles is fixed, and for this reason only a very narrow layer of the three-dimensional OCT image exhibits diffraction-limited resolution.

As a consequence, known OCT techniques re-quire a compromise: Either a principle such as TD-OCT is selected, in which excellent and homogeneous resolution of the three-dimensional OCT image is achieved at the cost of slowly moving mechanical scanning elements; or principles such as FD-OCT or SS-OCT are selected, in which high-speed 3D image acquisition can be achieved at the cost of a three-dimensional OCT image with inhomogeneous lateral optical resolution, which are largely below the diffraction limit of the imaging lens in most depth positions.

### Solution to Problem

One aspect of the present disclosure overcomes the above described compromise with a high-speed optical coherence tomography system for laterally moving objects, requiring only a single small, high-frequency phase-shift element, such as an oscillating micro-mirror or an optoelectronic modulator. The disclosure exploits the lateral motion of the inspected object under the OCT system, as for example in conveyor-belt applications. The disclosure consists of a low-coherence light source whose output is converted into a plane wave with a suitable lens. Using a beam splitter, this plane wave is simultaneously employed to illuminate a small volume of the inspected object, and it is also reflected by a small reference mirror with phase-shift functionality, making use of a suitable focusing lens. The phase shift of the reference beam is occurring at a high frequency of more than 100 Hz, typically several MHz, with total modulation depth of the optical path corresponding to at least one half of the center wave-length of the employed low-coherence light and less than the coherence length of the light. An imaging lens system creates an image of a planar section of the object in the plane of an image sensor. Through the beam splitter, the plane wave from the reference mirror is also incident on the image sensor plane, where the plane wave from the reference mirror interferes with the focused light reflected from the object. In each pixel of the image sensor, the temporally modulated light is demodulated, and the detected amplitude represents the local OCT signal from the illuminated volume around the focal plane in the object. The optical axis of the OCT system is inclined at an angle to the normal of the object surface, thus forming a slanted OCT arrangement. The lateral motion of the object provides a complete scanning of a three-dimensional volume of the object.

An optical coherence tomography imaging system according to one aspect of the present disclosure is for obtaining an image of the interior and/or surface of an object and includes a light source; a lens for converting light emitted from the light source into a plane wave; a beam splitter for splitting the plane wave into a first part and a second part; an imaging lens for focusing the first part of the plane wave into the object and imaging object light from a focal plane into a plane of an image sensor, the image sensor including a plurality of pixels arranged one-dimensionally or two-dimensionally; and a reference optical system including a collimation lens and a reference mirror unit for modulating an optical beam path between the reference minor unit and the beam splitter, the reference optical system propagating the second part of the plane wave, as a reference wave, into the plane of the image sensor though the beam splitter, in which an interference light of the reference wave and the object light is detected by the image sensor, and in which an optical axis of the optical coherence tomography imaging system, along which the imaging lens and the image sensor are arranged, is slanted at an angle to a surface normal of the object.

A total modulation depth of the optical beam path may be not less than one half of a center wavelength of the light that is emitted from the light source and not more than a coherence length of the light that is emitted from the light source such that an average oscillation amplitude of am interference signal detected in each pixel of the image sensor corresponds to information about local discontinuities of the refractive index in the object.

The imaging lens may focus the first part of the plane wave into the object that is moving along a transport direction. The optical axis may lie in a plane including the surface normal and the transport direction.

The optical coherence tomography imaging system according to one aspect of the present disclosure may further include a compensator arranged between the imaging lens and the object. The compensator may be formed in a wedge shape and has a refractive index that is substantially equal to a refractive index of the object.

An image obtaining method according to one aspect of the present disclosure is for obtaining an image of the interior and/or surface of an object and including converting, by a lens, light emitted from a light source into a plane wave; splitting, by a beam splitter, the plane wave into a first part and a second part; focusing, by an imaging lens, the first part of the plane wave into the object and imaging, by the imaging lens, an object light from a focal plane into a plane of an image sensor, the image sensor including a plurality of pixels arranged one-dimensionally or two-dimensionally and an optical axis along which the imaging lens and the image sensor are arranged being slanted at an angle to a surface normal of the object; modulating, by a reference optical system including a collimation lens and a reference minor unit, an optical beam path between the reference minor unit and the beam splitter, and propagating, by the reference optical system, the second part of the plane wave, as a reference wave, into the plane of the image sensor though the beam splitter; and detecting, by the image sensor, an interference light of the reference wave and the object light.

### BRIEF DESCRIPTION OF DRAWINGS

The disclosure will be better understood and objects other than those set forth above will become apparent when consideration is given to the following detailed description thereof. Such description makes reference to the annexed drawing.

FIG. 1 shows a cross section of the slanted OCT system according to the present disclosure.

FIG. 2 shows a typical TD-OCT signal in a pixel of the image sensor, consisting of an oscillatory part modulated with an envelope, whose center of gravity indicates the presence of a reflecting optical structure in the object at the corresponding 3D object location.

FIG. 3 shows a typical signal in a pixel of the image sensor of the slanted OCT system according to the present disclosure. The average demodulation amplitude corresponds to the local OCT signal.

FIG. 4 shows a cross section of a laterally moving object and the slanted focal plane with the pixels of the image sensors projected into the focal plane. In each of these projected pixels, the oscillatory OCT signal due to the phase-shift modulation is illustrated. The amplitude is largest at the optical interface in the object, where the refractive index is changing.

FIG. 5 shows the top view of the two-dimensional image sensor observing the slanted focal plane, where in each pixel the oscillatory OCT signal due to the phase-shift modulation is illustrated. In this example, the surface of the refractive index step inside the object is a plane that is rotated around the axis defined by transport direction 45. This inclination is not shown in FIG. 4. Therefore, the distance from the index step plane to the top surface of the object is smaller for the image sensor pixels in the front in FIG. 4, corresponding to the image sensor pixels at the bottom of FIG. 5; and the distance to the top surface of the object is larger for the image sensor pixels at the rear of FIG. 4, corresponding to image sensor pixels at the top of FIG. 5.

### DESCRIPTION OF EMBODIMENTS

It is an object of the disclosure to provide an OCT imaging system capable of acquiring three-dimensional OCT images of an inspected object with high speed.

It is a further object of the disclosure to provide a high-speed OCT imaging system producing three-dimensional OCT images with homogeneous, diffraction limited resolution throughout the inspected volume in the object.

It is another object of the disclosure to provide a high-speed, high-resolution OCT imaging system capable of acquiring OCT data in a complete sampling volume in the inspected object, so that the OCT imaging system can be employed in a conveyor-belt situation, in which the object consists of elongated material that is moved under the OCT imaging system, for example in a roll-to-roll configuration.

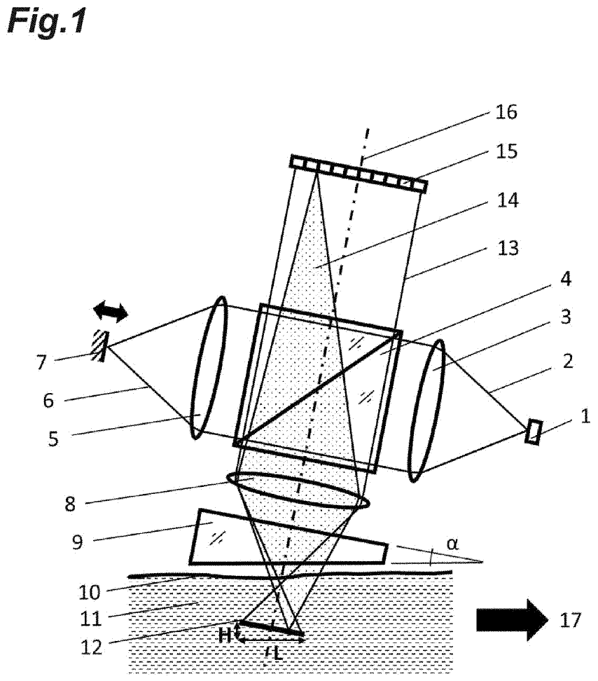

With the foregoing objects in view, the present disclosure is achieved with a slanted OCT setup illustrated in FIG. 1. Light source 1 is emitting low-coherence light into solid angle 2. The low-coherence light may have a coherence length of 1 μm to 100 μm. Optical lens 3 converts this light into a plane wave that is incident on beam-splitter 4. The beam splitter 5 splits the plane wave into a reflected part (first part) and a transmitted part (second part). The transmitted part of the plane wave is focused by lens (collimation lens) 5 into a small spot on reference minor (reference mirror unit) 7, providing the additional functionality of modulating the optical path length. The reference mirror reflects the light back into solid angle 6, and optical lens 5 is recreating a plane reference wave which is reflected by beam-splitter 4 into the direction of one-dimensional or two-dimensional image sensor 15. It can be seen that lens 5 and reference mirror 7 constitute a reference optical system and the reference optical system propagates the transmitted part of the plane wave, as the plane reference wave, into a plane of the image sensor though beam splitter 4.

Imaging lens 8 is focusing the reflected part of the plane wave of the low-coherence light from source 1 into a small volume of inspected object 10. Imaging aberrations can be reduced by employing wedge-shaped optical compensator 9, whose index of refraction should be as close as possible to the average index of refraction of bulk 11 of inspected object 10. In other words, optical compensator 9 has a refractive index that is substantially equal to a refractive index of the average refractive index of bulk 11 of inspected object 10.

Imaging lens 8 has the second function of imaging focal plane 12 onto the plane of image sensor 15 through imaging paths 14. That is, imaging lens 8 images object light 14 from focal plane 12 into the plane of image sensor 15. All object points on focal plane 12 in bulk 11 of inspected object 10 are simultaneously in focus and exhibit the same optical phase in image sensor plane 15. Plane reference wave 13 and focused object light 14 from focal plane 12 interfere in the plane of one-dimensional or two-dimensional image sensor 15, creating the desired OCT interference signal in each pixel of image sensor 15. The interference light of reference wave 13 and object light 14 is detected by image sensor 15.

It is also possible to implement the OCT system according to the present disclosure without optical compensator 9. In this case, focal plane 12 will exhibit an inclination that is smaller than tilt angle α, and the imaging quality of imaging lens 9 may be impaired because the imaging conditions are not symmetrical any more with respect to the optical axis.

Optical axis 16 is inclined such that optical axis 16 of the OCT system lies in the plane spanned by the surface normal and transport direction 17. That is, optical axis 16 is slanted an angle α with respect to the surface normal. Imaging lens 8 and image sensor 15 are arranged along optical axis 16. The angle α is measured with respect to the normal of object surface 10. As a consequence, focal plane 12 is also inclined by the same angle α, provided wedge-shaped optical compensator element 9 exhibits the same wedge angle α. Therefore, the inclination of focal plane 12 in the object results in a sampling height H over length L, related through H=L×tan(α). By way of an example, consider a moderate angle α=200 and a length L=1000 μm. This results in a height H=364 μm. The inclination angle α must be larger than zero so that H is larger than zero.

In case optical compensator 9 is employed, the angle must be smaller than the critical angle α_{crit}=arc sin (1/n) where n is the refractive index of the compensator element. Due to refraction at the bottom surface of the optical compensator, no light can exit the compensator element if the light is incident on the interface between the compensator element and air at angles larger than the critical angle. Therefore, the following inequality must hold for angle α: 0<α<α_{crit} if compensator element 9 is employed.

In order to ensure that the OCT interference signals in the pixels of image sensor 15 are originating from the scattering points in focal plane 12, it is necessary that the optical path from focal plane 12 to the center of beam-splitter 4 corresponds to the optical path from reference minor 7 to the center of beam-splitter 4. In order to generate one period of a TD-OCT interference signal in one-dimensional or two-dimensional image sensor plane 15, it is sufficient to change the optical path difference of the light reflected from reference minor 7 by an amount corresponding to the central wavelength λ of the low-coherence light from light source 1. As a consequence, if the surface of the reference mirror 7, which is modulating the optical path length, is oscillating with an amplitude M of λ/4, a periodic temporal interference signal is generated in the plane of image sensor 15, containing the sought information about the local OCT signal amplitude.

It is also possible to provide a larger amplitude M of the surface of reference minor 7, yielding an optical path difference of a multiple of λ/2. As a consequence, several periods of the TD-OCT signal will be traversed in each pixel, as explained below. Since a typical TD-OCT signal has an envelope with a width related to the optical coherence length OCL of the low-coherence light emitted by light source 1, the maximal optical path difference must be smaller than this optical coherence length. Therefore, the following inequality should hold for the excursion amplitude M of reference mirror: λ/4≤M<OCL/2.

The frequency with which reference mirror 7 should be modulating the optical path length is dictated by the speed of lateral motion 17 of inspected object 11. During the acquisition of the OCT signal from one position of focal plane 12, this focal plane should not move more than a distance corresponding to half the pixel spacing in image sensor plane 15. For very slowly moving objects 11, a modulation frequency of about 100 Hz may be adequate. For fast-moving objects 11 (for example a latera speed of 1 m/s), a modulation frequency in excess of 1 MHz may be required. For this reason, path-length modulation reference mirror 7 may be small, so that such high frequencies are possible.

An optical device that can modulate the optical path difference is an oscillating quartz with a specularly reflecting surface. Quartz crystals used as stable time bases for electronics can be operated at frequencies of several tens of MHz. Since the minimum mirror amplitude M required to traverse a full period of the TD-OCT signal in the pixels of image sensor 15 is only λ/4, such high oscillation frequencies can be practically sustained. By way of an example, if a center wavelength of λ=800 nm for the low-coherence light from source 1 is employed, the vibration amplitude M of oscillating reference mirror 7 can be as small as 200 nm.

A second optical device that can modulate the optical path difference is an electro-optic modulator in front of a small stationary mirror. That is, the reference mirror unit may include a stationary mirror and an electro-optic modulator in front of the stationary minor. Phase-modulating electro-optic modulators are commercially available offering modulation frequencies of several GHz.

If high-frequency mechanical oscillations of small reference mirror 7 are not possible with the required amplitude M because of air drag, small reference mirror 7 can be placed in a vacuum container with a window facing collimation lens 5.

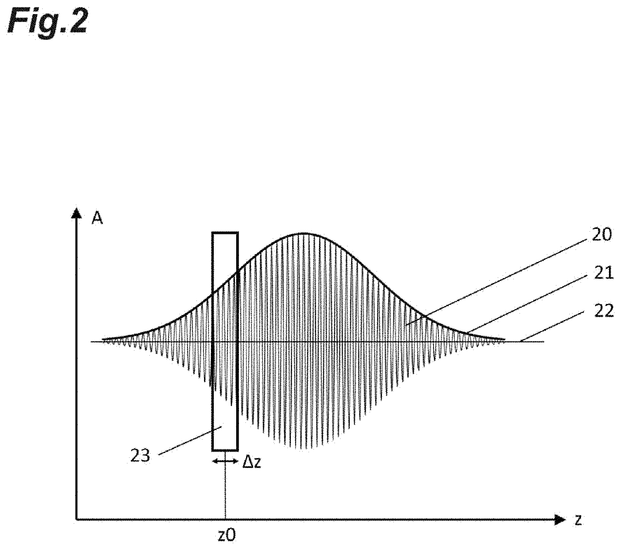

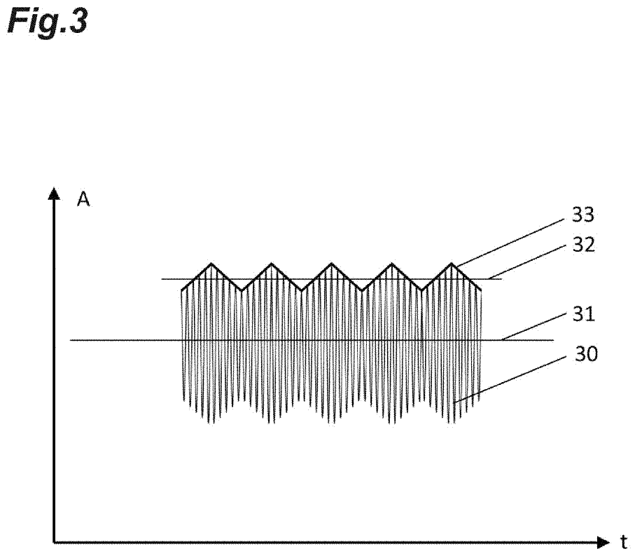

Strategies for acquiring OCT signals with the slanted OCT system according to the present disclosure are illustrated in FIG. 2 and FIG. 3. If z indicates the total optical path-length of phase-shifting minor 7, the amplitude A(z) of the TD-OCT interference signal observed in the pixels of image sensor 15 has a shape as shown in FIG. 2: It consists of oscillations 20 with the period of λ measured in optical path difference, where λ is the center frequency of the low-coherence light from source 1. The oscillations are modulated with envelope 21, around offset 22. The width of envelope 21 is related to the coherence length of the low-coherence light from source 1. In a conventional TD-OCT system, the range of z encloses the complete depth of interest in the observed object. In the slanted OCT system according to the present disclosure, lateral movement 17 is employed in combination with the non-zero angle of focal plane 12 to sample the complete OCT signal in the bulk of object 11. For one position of focal plane 12, it is therefore sufficient to probe the local amplitude A(z0). This is achieved by oscillating small reference mirror 7 with a total path length difference 2M of at least λ/2, i.e. a complete period of OCT oscillation signal 20. This corresponds to sampling OCT signal 20 in narrow window 23 of width Δz at position z0. If reference mirror 7 is oscillating, the TD-OCT signal is repeatedly traversed, resulting in the OCT amplitude signal A(t) illustrated in FIG. 3, where it is assumed that the total excursion 2M of reference mirror 7 is several λ, and the oscillation of reference mirror 7 has a sawtooth form.

In each pixel of image sensor 15, temporal OCT signal 30 as illustrated in FIG. 3 is observed. In each pixel, OCT signal 30 must be processed such that offset value 31 and average signal amplitude 32 are obtained.

A first method to accomplish this parameter extraction consists of a synchronous signal detection and demodulation technique, requiring precise knowledge of the temporal frequency with which OCT signal 30 is modulated, and this frequency is determined by the modulation frequency of phase-shifting reference mirror 7. In each period of the OCT signal, a number n 3 of signal samples is acquired and averaged over all periods of the same OCT signal. From these sample values, the three parameters phase, offset and modulation amplitude can be determined according to known calculation methods.

A second method consists of the detection of offset value 31, subtracting it from OCT signal 30, rectifying the resulting pure AC signal, and determining average amplitude 32. Subtracting offset value 31 can also be accomplished by AC coupling of the photosensor signal in each pixel, thus removing all DC contributions (i.e. offset values) to the OCT signals in each pixel.

Another method consists of using a known electronic circuit for determining the maximum and the minimum of the OCT signal within the observation time. The difference between maximum and minimum is a measure for the OCT modulation amplitude that is sought.

Since OCT signals can be processed individually in each pixel of one-dimensional or two-dimensional image sensor 15, the method according to the present disclosure does not require combination of signals from different pixels, which would be adversely affected by fixed pattern noise, spatially varying offset values in the pixel responses, or spatially varying sensitivity in the pixel responses.

Lateral motion 17 of inspected object 11 makes it possible to collect the OCT signal amplitude A(x,y,z) at all positions (x,y,z) in the bulk of the object. Assuming image sensor 15 is imaging a distance D of focal plane 12, knowledge of the angle α allows the calculation of the height H=D×sin(a) of the sampling volume. The lateral dimension of the sampling volume is given by the side of image sensor 15 projected onto focal plane 12. Lateral motion 17 of object 11 allows the continuous sampling of OCT signals from all height positions within sampling height H.

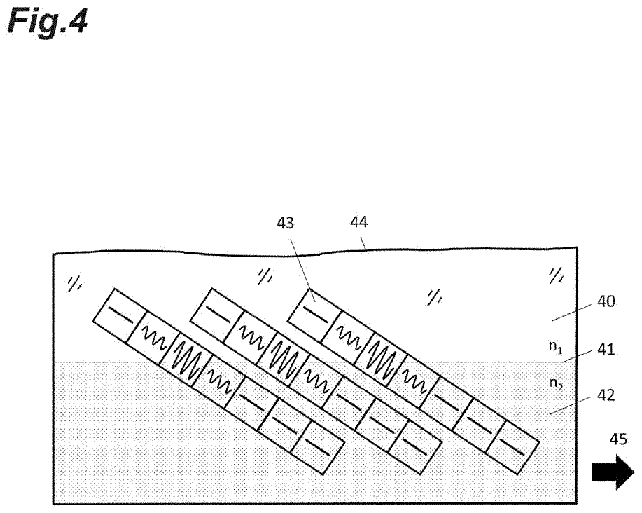

The extraction of the OCT demodulation signals from the individual pixels and their relation to the variations of the index of refraction within the bulk of the object is explained in FIG. 4. For illustration purposes, the object is assumed to consist of only two homogeneous, partly transparent parts: Upper part 40 with refractive index n₁, separated by index step plane 41 from second part 42 with refractive index n₂. Focal plane 43 is illustrated with pixels projected back from the image sensor plane into focal plane 43. At each position of focal plane 43, the OCT signals observed by the corresponding pixels in the image sensor plane are illustrated with an oscillating signal. As is illustrated in FIG. 4, OCT signal amplitude is largest at the interface between the material parts with differing refractive indices. The oscillation amplitudes become smaller for increasing distances from index step plane 41. Once the distance from index step plane 41 is larger than the coherence length of the employed low-coherence light source, the oscillations of the OCT signal are vanishing in the noise of the pixel signals.

For each lateral position of focal plane 43 it is therefore possible to determine the local distribution of the refractive index steps Δn(x,y,z) in focal plane 43, based on the amplitudes of the demodulated pixel signals. Since the object is moved laterally in transport direction 45, stationary focal plane 43 is employed for the local sampling of OCT signals from the measurement volume in the object determined by the height H of the focal plane illustrated in FIG. 1, and the width W of the focal plane determined by the width of the image sensor and the magnification of imaging lens 8.

Since in some cases it cannot be assured that object surface 44 is plane, the imaging geometry can be chosen such that focal plane 43 is intersecting object surface 44. As a consequence, the index discontinuity at object surface 44 is always visible in the sensor plane, and the distribution of the refractive index in the bulk of the object can be related to object surface 44.

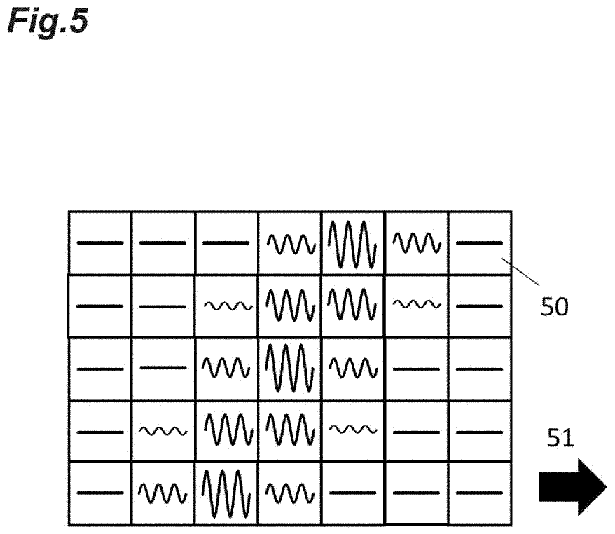

For clarity of the image acquisition process, FIG. 5 illustrates an example distribution of OCT signals in the image sensor plane. Assuming that the focal plane is slanted as illustrated in FIG. 4, it can be deduced that the upper lines of the image sensor show a discontinuity of the index of refraction that is more distant from the object surface than the lower lines. Obviously, more than one index discontinuity can be detected in each line of the image sensor, provided the distance between these discontinuity steps is larger than the coherence length of the employed low-coherence light. Lateral transport 51 of the object allows the image sensor continuously to inspect the OCT signals from the various depths of the object as illustrated in FIG. 4.

The features of the present disclosure can be described as follows:

Feature 1

An optical coherence tomography imaging system without any large moving optomechanical parts for the continuous inspection of laterally moving objects as in conveyor-belt applications, comprising

a low-coherence light source with a lens for the generation of a plane wave, a beam splitter, an imaging lens for imaging the light from a focal plane into the plane of an image sensor and a reference beam path consisting of a collimation lens and a reference mirror with the capability of modulating the optical beam path,
characterized in that the total modulation depth of the optical path corresponds to at least one half of the center wavelength of the employed low-coherence light and at most to the coherence length of this light, such that the average oscillation amplitude of the OCT photo-signal in each pixel of the image sensor corresponds to information about local discontinuities of the refractive index in the inspected volume of the object; and
the optical axis of the OCT system is slanted at an angle to the surface normal, such that the optical axis of the OCT system lies in the plane of the surface normal and the transport direction. Due to the lateral transport of the object, the focal plane is moved laterally throughout the object, and the local discontinuities of the refractive index of the object can thus be imaged completely.

Feature 2

An optical coherence tomography imaging system without any large moving optomechanical parts consists of a low-coherence light source which is converted into a plane wave with a suitable lens. Using a beam splitter, this plane wave is simultaneously employed to illuminate a small volume of the inspected object, and it is also reflected by a small reference mirror with phase-shift modulation functionality, making use of a suitable focusing lens. The phase shift of the reference beam is occurring at a high frequency of more than 100 Hz, with a total modulation depth of the optical path corresponding to at least one half of the center wavelength of the employed light and less than the coherence length of the light. An imaging lens system creates an image of a planar section of the object in the plane of an image sensor. Through the beam splitter, the planar wave from the reference mirror is also incident on the image sensor plane, where the plane wave from the reference mirror interferes with the focused light reflected from the object. In each pixel of the image sensor, the temporally modulated light is demodulated, and the detected amplitude represents the local OCT signal from the illuminated volume around the focal plane in the object. The optical axis of the OCT system is inclined at an angle to the normal of the object surface in the direction of object transport, thus forming a slanted OCT arrangement. The lateral motion of the object, for example in a conveyor-belt application, provides for a complete scanning of a three-dimensional volume of the object.

1: An optical coherence tomography imaging system for obtaining an image of an interior and/or a surface of an object, comprising:
a light source;
a lens for converting light emitted from the light source into a plane wave;
a beam splitter for splitting the plane wave into a first part and a second part;
an imaging lens for focusing the first part of the plane wave into the object and imaging object light from a focal plane into a plane of an image sensor, the image sensor including a plurality of pixels arranged one-dimensionally or two-dimensionally; and
a reference optical system including a collimation lens and a reference mirror unit for modulating an optical beam path between the reference mirror unit and the beam splitter, the reference optical system propagating the second part of the plane wave, as a reference wave, into the plane of the image sensor though the beam splitter,
wherein an interference light of the reference wave and the object light is detected by the image sensor, and
wherein an optical axis of the optical coherence tomography imaging system, along which the imaging lens and the image sensor are arranged, is slanted at an angle to a surface normal of the object.

2: The optical coherence tomography imaging system according to claim 1,
wherein a total modulation depth of the optical beam path is not less than one half of a center wavelength of the light that is emitted from the light source and not more than a coherence length of the light that is emitted from the light source such that an average oscillation amplitude of an interference signal detected in each pixel of the image sensor corresponds to information about local discontinuities of a refractive index in the object.

3: The optical coherence tomography imaging system according to claim 1,
wherein the imaging lens focuses the first part of the plane wave into the object that is moving along a transport direction, and
wherein the optical axis lies in a plane including the surface normal and the transport direction.

4: The optical coherence tomography imaging system according to claim 1, further comprising
a compensator arranged between the imaging lens and the object,
wherein the compensator is formed in a wedge shape and has a refractive index that is substantially equal to a refractive index of the object.

5: An image obtaining method for obtaining an image of an interior and/or a surface of an object, comprising:
converting, by a lens, light emitted from a light source into a plane wave;
splitting, by a beam splitter, the plane wave into a first part and a second part;
focusing, by an imaging lens, the first part of the plane wave into the object and imaging, by the imaging lens, object light from a focal plane into a plane of an image sensor, the image sensor including a plurality of pixels arranged one-dimensionally or two-dimensionally and an optical axis along which the imaging lens and the image sensor are arranged being slanted at an angle to a surface normal of the object;
modulating, by a reference optical system including a collimation lens and a reference mirror unit, an optical beam path between the reference mirror unit and the beam splitter, and propagating, by the reference optical system, the second part of the plane wave, as a reference wave, into the plane of the image sensor though the beam splitter; and
detecting, by the image sensor, an interference light of the reference wave and the object light.
